(19) United States
(12) Patent Application Publication
(10) Pub. No.: US 2008/0193715 A1
(43) Pub. Date: Aug. 14, 2008

(54) Process For Producing a Quartz Glass Component For Use In Semiconductor Manufacture And Component Produced By This Process

(75) Inventors: Juergen Weber, Kleinostheim (DE); Ulrich kirst, Mainz (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: HERAEUS QUARZGLAS GMGH & CO. KG, HANAU (DE)

(21) Appl. No.: 11/883,617

(22) PCT Filed: Jan. 18, 2006
(86) PCT No.: PCT/EP06/00381

§ 371 Date: Oct. 30, 2007

(30) Foreign Application Priority Data
Feb. 3, 2005 (DE) 10-2005-005-196.0

(51) Int. Cl. B32B 3/00; B44C 1/22

(52) U.S. Cl. 428/141; 216/24

(57) ABSTRACT

Quartz glass components for use in semiconductor manufacture are produced by mechanically machining the surface of a quartz glass blank so as to produce an initial average surface roughness R_{a,0}. The thus machined component surface is then cleaned in an etching solution. The invention relates to the optimisation of particle formation on such components, during the first intended use already. It is proposed to produce an initial average surface roughness R_{a,0} of at least 0.2 μm by mechanical machining, and to adjust etching intensity and duration so that an actual etching depth of at least 10 μm is achieved. A quartz glass component produced by this process for use in semiconductor manufacture is characterised in that it comprises, before its first intended use, a surface produced by mechanical machining and etching having an etched structure with an average surface roughness R_{a,1} ranging from 0.6 μm to 8 μm, and in that a weight loss of less than 0.4 μg/(mm²×min) which is substantially constant in time is achieved when etching the component with a 10% solution of hydrofluoric acid.

The present invention relates to a process for producing a quartz glass component for use in semiconductor manufacture in that an initial average surface roughness R_{a,0} is produced by mechanically machining the surface of a quartz glass blank, and the component surface machined in this way is subjected to an etching treatment.

Furthermore, the invention relates to a quartz glass component produced by this process for use in semiconductor manufacture, which component, before its first intended use, comprises a surface produced by mechanical machining and etching having an etched structure.

Quartz glass components are used in semiconductor manufacture in the form of reactors and apparatuses for the treatment of wafers, wafer carriers, belts, crucibles, or the like. In these applications the quartz glass components are often exposed to high thermal loads and chemically aggressive environments.

Special emphasis is laid on the absence of contamination and on the particle formation emanating from the components. Particles reduce the process output and are therefore extremely undesired. A distinction can be made between particles detaching from the quartz glass component due to corrosive attack and particles which form part of material layers that for instance in sputtering or vaporizing processes deposit on the surfaces of the quartz glass components and detach therefrom.

In this context the surface quality of the quartz glass components plays an important role. On the one hand, a certain surface roughness is desired for the reason that material layers adhere to rough surfaces in a better way, which reduces the probability that layer parts might detach, as well as the frequency of the necessary cleaning measures, which measures normally comprise etching in a hydrofluoric acid-containing solution. Therefore, those surfaces that might be important in this respect are usually treated and roughened by grinding, polishing or sandblasting.

On the other hand, mechanical machining of the surface for setting a desired roughness produces surface defects which, in turn, during use of the quartz glass component lead to particle formation. To ensure a surface that is as clean and particle-free as possible, the quartz glass components are therefore cleaned in an etching solution for a short period after chemical machining at the factory or by the user. The surface of the components treated in this way is free from particles and is distinguished by a surface roughness predetermined by the mechanical finishing operation. Depending on the duration of the cleaning process in etching solution, a marginal etched structure might also be visible.

However, it has been found that during the intended use of the components these measures cannot prevent particle formation to an appropriate degree.

It is therefore the object of the present invention to indicate an inexpensive process for machining the surface of a quartz glass component that permits the reproducible manufacture of components with small particle formation.

Moreover, it is the object of the present invention to provide a component which already in its first intended use in semiconductor manufacture is distinguished by small particle formation.

As for the process, this object starting from the aforementioned process is achieved according to the invention in that an initial average surface roughness R_{a,0} of at least 0.2 μm is set due to mechanical machining, and that intensity and duration of the etching treatment are set such that an actual etching depth of at least 10 μm is obtained.

According to the invention the surface of a quartz glass blank is mechanically machined, and an initial average surface roughness R_{a,0} of 0.2 μm or more is set in this process. As has been explained above, a certain degree of roughness is desired for the purpose of improved adhesion of the material layers deposited in the intended use on the surface of the quartz glass component.

On the other hand, however, it has been found that the particle formation is the greater the higher the initial surface roughness is that is set by mechanical machining. Particle formation can be reduced by a cleaning process following mechanical machining. However, it has been found that the standard cleaning treatments are inadequate for this purpose. Rather, it has been found that the observation of a minimum etching removal of at least 10 μm is needed.

On the other hand, however, a component with a surface that is still adequately rough with respect to the adhesion of the material layers will only be obtained after such a downstream etching process if the initial average surface roughness R_{a,0} is at least 0.2 μm before the etching process.

Therefore, according to the invention the initial average surface roughness R_{a,0} is first determined after mechanical machining if said value is not known, and it is ensured that R_{a,0} is greater than 0.2 μm. Subsequently, the surface of the blank is removed up to a depth of at least 10 μm. A quartz class component is thereby obtained that is distinguished by low particle formation.

The definition of the average surface roughness Rₐ follows from EN ISO 4287, the measurement conditions from EN ISO 4288 or EN ISO 3274, depending on whether the surface of the blank is finished by grinding or sandblasting (non-periodic surface profile) or by turning (periodic surface profile).

At higher initial surface roughnesses (R_{a,0} around 0.4 μm or more), it has been found that a minimum etching removal must be observed, said removal depending on the surface roughness given by mechanical machining.

Therefore, the initial average surface roughness R_{a,0} is determined, and the actual etching depth is set to be greater than a minimum etching depthₘᵢₙ defined in response to R_{a,0}.

In this procedure, a specific minimum etching removal is first determined on the basis of the determined or known R_{a,0} value, and the blank is thus etched in a correspondingly long and intensive process. The minimum etching removal specific for the R_{a,0} value follows from a few etching tests as that removal depth from which during further etching of the blank a constant etching rate [mm/min] or a weight loss substantially constant in time is obtained.

In this respect, starting from an initial average surface roughness R_{a,0} of 0.4 μm or more, a procedure has turned out to be particularly advantageous in which the etching depthₘᵢₙ satisfies the following dimensioning rule:

etching depthₘᵢₙ=70+60×ln R_{a,0}[in μm],

preferably the following dimensioning rule:

etching depthₘᵢₙ=75+60×ln R_{a,0}[in μm].

If the initial average surface roughness R_{a,0} of the blank is known, this dimensioning rule permits a simple determination of that etching removal that is sufficient for obtaining a quartz glass component which is distinguished by small particle generation during the intended use and simultaneously by a high surface roughness that is adequate with respect to the adhesion of deposited material layers.

It has been found that particularly with ground quartz glass surfaces having an initial average surface roughness R_{a,0} of 0.4 μm or more, the minimum removal etching depthₘᵢₙ is normally in the range between 15 μm and 120 μm, preferably between 20 μm and 100 μm.

To minimize the time spent on the etching treatment and the material loss, the etching removal (after mechanical machining) is kept as small as possible. Therefore, a procedure is preferred in which intensity and duration of the etching treatment are set such that the actual etching depth is by not more than 20 μm greater than the etching depthₘᵢₙ.

Furthermore, it has turned out to be useful when an initial average surface roughness R_{a,0} of at least 0.3 μm and not more than 1.6 μm, preferably around 0.8 μm, is produced by mechanically machining the surface.

Following an etching removal of at least 10 μm or in the order of the respective specific minimum etching removal etching depthₘᵢₙ, quartz glass components having a sufficiently high surface roughness with respect to the adhesion of deposited material layers are obtained from quartz glass blanks with initial average surface roughnesses in the indicated range.

In this context it has also turned out to be particularly advantageous when the etching treatment produces an etched structure having an actual average surface roughness R_{a,1} which in the range of 0.4 μm to 7 μm is greater than the initial average surface roughness R_{a,0}.

As for the quartz glass component for use in semiconductor manufacture, the above-indicated object is achieved according to the invention in that the component has a surface characterized by
a) an average surface roughness R_{a,1} in the range between 0.6 μm and 8 μm, and
b) a weight loss substantially constant in time of less than 0.4 μg/(mm²×min) when etched in 10% hydrofluoric acid at room temperature.

Before the first intended use in semiconductor manufacture the surface of the quartz glass component according to the invention has an etched structure which is substantially characterized by two properties. On the one hand, it is characterized by an average surface roughness in the range between 0.6 μm and 8 μm. On the other hand by a substantial constancy of the etching behavior vis-à-vis subsequent etching treatments that is present right from the beginning.

The average surface roughness in the range between 0.6 μm and 8 μm ensures an adequate adhesion of material layers deposited on the surface.

The constancy of the etching behavior manifests itself on the one hand in that from the first intended use of the component a weight loss substantially constant in time is obtained by further etching of the component in 10% hydrofluoric acid, and on the other hand in that the weight loss with less than 0.4 μg/(mm²×min) is very low. The measured weight loss depends on the size of the surface of the quartz glass component that is constantly decreasing during the etching process. This effect is eliminated by standardization to the respective surface size. A weight loss substantially constant in time is meant to be a weight loss [μg] standardized to [mm²×min] which deviates from a mean value (arithmetic mean) by not more than 0.05 μg.

It has been found that a variable etching rate of a quartz glass component is accompanied by a significant particle generation whereas a weight loss that is constant in time is imperative for small particle generation in the quartz glass component. Hence, this feature simultaneously characterizes the qualification of the component according to the invention for use in semiconductor manufacture with respect to particle generation.

Moreover, a weight loss constant in time (standardized to the respective surface) contributes to a certain maintenance of the average surface roughness and thus also to the maintenance of the adhesive properties of the quartz glass component also after repeated cleaning in hydrofluoric-acid containing solution—at any rate this has been found at initial average roughnesses Rₐ of 0.8 μm or less.

The component according to the invention can be obtained with the help of the above-described method, particularly by mechanical machining observing an initial average surface roughness R_{a,0} of at least 0.2 μm, and a subsequent etching treatment with a minimum etching removal specific for the R_{a,0} value.

A further improvement of the component according to the invention with respect to small particle generation is accomplished when during etching under the above-mentioned conditions a weight loss substantially constant in time of less than 0.25 μg/(mm²×min) is set.

It has been found that the etched structure in such a component is free from microcracks.

Use of the component according to the invention in the form of a flange for a single-wafer treatment device has turned out to be particularly advantageous.

The single-wafer treatment device is positioned in the direct vicinity of the wafer to be treated, or said wafer directly rests on the single-wafer treatment device, so that particle generation by this device poses great problems.

The invention will now be described in more detail with reference to an embodiment and a patent drawing, which shows in detail in:

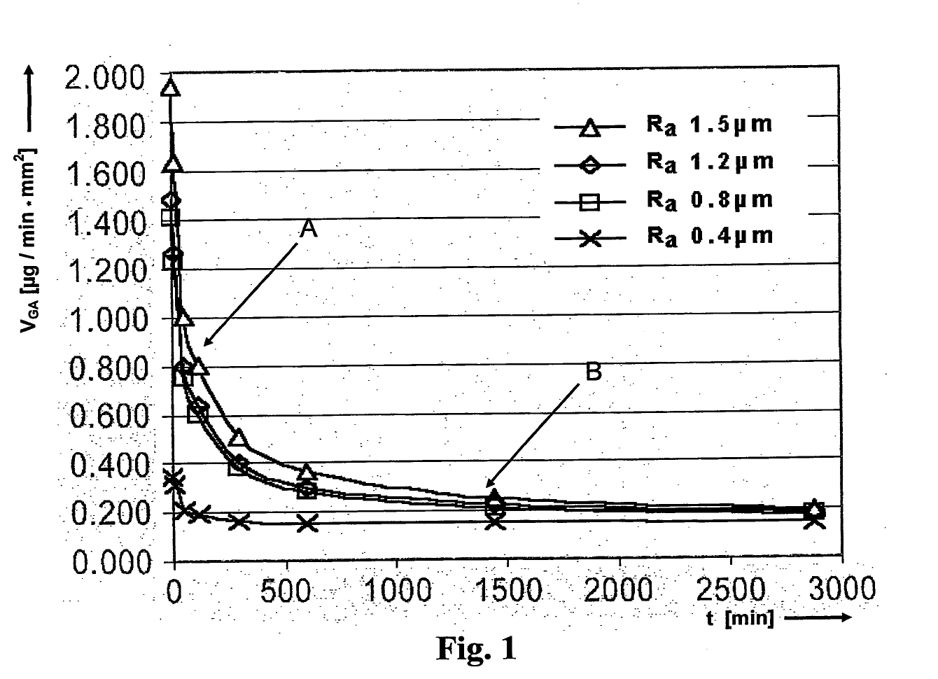

FIG. 1 a diagram showing the etching removal in time in quartz glass blanks with mechanically differently pretreated surfaces, and

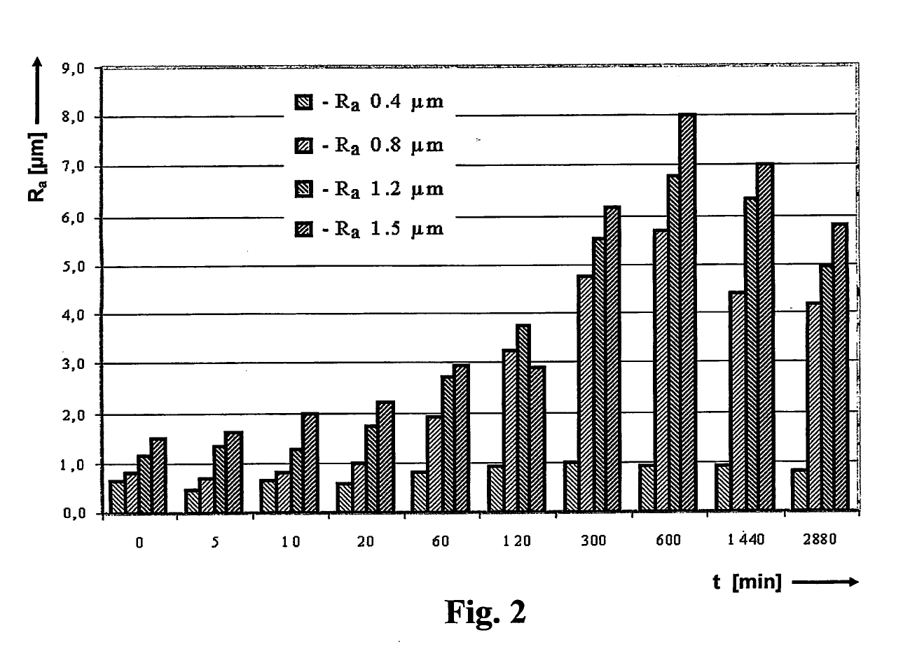

FIG. 2 a bar diagram showing the development of the surface roughness with the etching duration in quartz glass blanks having mechanically differently pretreated surfaces.

Cylindrical quartz glass blanks are made from naturally occurring raw materials of quartz and the planar surfaces are coarsely ground to the predetermined final dimension by means of a grinding device equipped in the end with a D46 grinding wheel (according to FEPA standard). The finishing treatment of the planar surface is carried out using a CNC grinding machine in a multistage treatment process in which the degree of grinding is continuously refined. Components are thereby obtained with four different surface qualities, each being characterized by its initial average roughness R_{a,0}. These are summarized in Table 1.

TABLE 1

| | | | | Max. |
|---|---|---|---|---|
| | | | | roughness |
| | | | | depth after |
| | Initial average | Etching | Etching | etching |
| | roughness | durationₘᵢₙ | depthₘᵢₙ | durationₘᵢₙ |
| Sample | depth R_{a,0} [μm] | [min] | [μm] | [mm] |
| 1 | 0.4 | 300 | 15 | 1.0 |
| 2 | 0.8 | 1200 | 60 | 4.4 |
| 3 | 1.2 | 1600 | 80 | 6.0 |
| 4 | 1.5 | ~2000 | ~100 | 6.5 |

The quartz glass samples obtained in this way are subsequently etched in a hydrofluoric-acid etching solution in which at room temperature an etching rate of about 0.05 μm/min is set (on condition of a defect-free surface).

The etching solution is a 10% HF solution (in distilled water).

Samples with the different surface qualities are each subjected in this etching solution to etching durations ranging between 5 minutes and 2880 minutes (48 hours). The layer thicknesses removed in this process are thus within the range between 0.125 μm and 144 μm. It has become apparent in these test series that all sample qualities first show a higher etching rate that after a given etching duration assumes a substantially constant etching rate.

The corresponding time curves of the etching rates for the four sample qualities are shown in the diagram of FIG. 1. The weight loss in time V_{GA}, based on the actual surface of the component, is there plotted on the y-axis [μg/min×mm²], and the etching duration t in [min] on the x-axis. All samples show an initially approximately exponential weight loss (area A) which after further etching passes into a linear curve (area B). It can clearly be seen that in the samples with the initially smallest average surface roughness the transition towards the linear weight loss sets in much earlier than in the samples having the higher average surface roughness. The approximate etching durations up to the beginning of the linear curve are plotted for the respective surface qualities in column 3 under “etching durationₘᵢₙ”. Column 4 shows the values converted into “etching depths”.

It has been found that the quartz glass components of all tested surface qualities show a very small particle generation in the intended use, on condition that after their mechanical finishing treatment they have been subjected to an etching treatment in which at least a removal according to the “etching depthₘᵢₙ” outlined in Table 1 is carried out. At smaller etching depths (shorter etching treatments at a given etching rate), particle generation is still observed during use of the corresponding components.

Under the aspect of costs the conclusion is first drawn from this result that an initially smoother surface should be preferred because it yields a quartz glass component with small particle generation within a considerably shorter etching period. However, two other aspects must here be paid attention to. On the one hand, the production of an initially smoother surface requires considerably greater grinding and polishing efforts. On the other hand, after an etching process with a duration of at least “etching durationₘᵢₙ” the samples with an initially smoother surface show a surface roughness less than the surface roughness of samples having an initially coarser surface, as shall be explained in more detail in the following with reference to the bar diagram of FIG. 2.

FIG. 2 shows the change in the average surface roughness Rₐ after different etching periods [in minutes] for the different surface qualities. It becomes apparent that in all samples the average surface roughness Rₐ is first increasing in the course of the etching process and then decreasing again. Increase and maximum of the surface roughness are much more pronounced in the samples having an initially rough surface than in the sample with the initially smoothest surface (sample 1). In this sample a maximum of the average surface roughness is about Rₐ=1.0 μm during the whole etching test. The three other samples exhibit roughness maxima that are above the respective initial value by the factor 6 to 7. Likewise, the roughness values after an etching period corresponding to the sample-specific “etching durationₘᵢₙ” are in these samples still above the respective initial value by the factor 4 to 5. The sample-specific maximal Rₐ values after an etching period of “etching durationₘᵢₙ” can be found in column 5 of Table 1.

For applications in which high adhesion of deposited material layers is also of importance, high surface roughnesses are better suited. In this respect sample 2 having an initial average roughness Rₐ=0.8 μm should be preferred. This sample is on the one hand distinguished by a reasonably small value for “etching durationₘᵢₙ” (1200 min) and still exhibits, on the other hand, an adequately high surface roughness with an Rₐ value above 4 μm after this etching duration.

Based on the data indicated in Table 1, the necessary intensity and duration of an etching treatment can be estimated by way of the following dimensioning rule: etching depthₘᵢₙ[in μm]=70+60×ln R_{a,0}[in μm].

In consideration of a safety factor the actual etching depth should be in practice at least 5 μm deeper than the minimum etching depthₘᵢₙ, but not more than 20 μm for reasons of costs.

### EXAMPLE

Using the process according to the invention a single-wafer holder of quartz glass is produced. This component has essentially the shape of a ring. All surfaces, i.e. the two flat sides and the cylindrical surfaces, of a corresponding quartz glass blank are ground as explained above until an average surface roughness of 0.8 μm is obtained.

The blank treated in this way is then treated in 10% HF solution for 1440 minutes. The resulting component shows an etched structure with an average surface roughness Rₐ around 4.3 μm, which is entirely free from microcracks.

The component is distinguished by small particle generation in the intended use and by high adhesion for the material layers deposited thereon.

A typical feature of the quartz glass holder produced in this way resides in a substantially constant etching behavior during further etching in 10% hydrofluoric. acid. This is above all reflected by a low weight loss of about 0.2 μm/(mm²×min). The weight loss is moreover constant in time, as is also demonstrated by FIG. 1. In a further etching process having an etching duration of 1440 minutes (and thus a total etching duration of 2880 minutes) a weight loss of about 0.19 μm/(mm²×min) is observed.

Moreover, the average surface roughness remains at a relatively high level of about 4.1 μm after this further etching process (as shown in FIG. 2).

### COMPARATIVE EXAMPLE

A single-wafer holder of quartz glass is produced and mechanically machined, as described in Example 1. The average surface roughness is 0.8 μm. The blank treated in this way is then cleaned in 10% HF solution for 20 minutes.

The resulting component has an etched structure with an average surface roughness Rₐ around 1 μm. In the intended use in a semiconductor manufacturing process a distinct particle generation is observed.

When checking the etching behavior of the holder it becomes apparent that the quartz glass while being etched in 10% HF solution shows an initially great weight loss of about 1 μg/(mm²×min), which is however rapidly decreasing during further etching.

1. A process for producing a quartz glass component used in semiconductor manufacture comprising the steps of: mechanically machining the surface of a quartz glass blank to produce a component surface having an initial average surface roughness R_{a,0}, and subjecting the component surface to an etching treatment, wherein the initial average surface roughness R_{a,0} is at least 0.2 μm, and wherein the etching treatment is of an intensity and duration such that an actual etching depth of at least 10 μm is obtained.

2. The process according to claim 1, wherein the initial average surface roughness R_{a,0} is determined, and wherein the actual etching depth is selected so as to be higher than a minimum etching depthₘᵢₙ defined with respect to R_{a,0}.

3. The process according to claim 2, wherein where the initial average surface roughness R_{a,0} is 0.4 μm or more, the minimum etching depthₘᵢₙ satisfies the following dimensioning rule:
Minimum etching depthₘᵢₙ [in μm]=70+60×ln(R_{a,0}) [in μm]

4. The process according to claim 3, wherein the minimum etching depthₘᵢₙ satisfies the following dimensioning rule:
Minimum etching depthₘᵢₙ [in μm]=75+60×ln(R_{a,0}) [in μm]

5. The process according to claim 2, wherein the minimum etching depthₘᵢₙ is in a range between 15 μm and 120 μm.

6. The process according to claim 2, wherein the etching treatment is of an intensity and duration such that the actual etching depth is not more than 20 μm greater than the minimum etching depthₘᵢₙ.

7. The process according to claim 1, wherein the initial average surface roughness R_{a,0} of produced by mechanically machining the surface is at least 0.3 μm and not more than 1.6 μm.

8. The process according to claim 1, wherein the etching treatment produces an etched surface having an actual average surface roughness R_{a,1} which is in a range of 0.4 μm to 7 μm and is higher than the initial average surface roughness R_{a,0}.

9. A quartz glass component used in in semiconductor manufacture, said component comprising a surface produced by first mechanical machining an initial surface to yield a roughened surface and then etching the roughened surface so as to form an etched surface having:
a) an average surface roughness R_{a,1} in a range between 0.6 μm and 8 μm; and
b) a substantially constant weight loss in time of less than 0.4 μg/(mm²×min) when etched in 10% hydrofluoric acid at room temperature.

10. The component according to claim 9, wherein the weight loss is selected so as to be less than 0.25 μg/(mm²×mm).

11. The component according to claim 9, wherein the etched structure is free of microcracks.

12. The component according to claim 9, wherein said component is shaped in a form of a flange for a single-wafer treatment device.

13. The process according to claim 2, wherein the minimum etching depthₘᵢₙ is in a range between 20 μm and 100 μm.

14. The process according to claim 1, wherein the initial average surface roughness R_{a,0} is approximately 0.8 μm.

15. The process according to claim 2, wherein the initial average surface roughness R_{a,0} is at least 0.3 μm and not more than 1.6 μm.

16. The process according to claim 2, wherein the etching treatment produces an etched surface having an actual average surface roughness R_{a,1} that is in a range of 0.4 μm to 7 μm and is higher than the initial average surface roughness R_{a,0}.
